(19) United States
(12) Patent Application Publication
(10) Pub. No.: US 2015/0064304 A1
(43) Pub. Date: Mar. 5, 2015

(54) PROBIOTIC LOZENGE, METHOD OF MAKING SAME, AND USES THEREOF

(71) Applicant: Mario Medri, Miami Lakes, FL (US)

(72) Inventor: Mario Medri, Miami Lakes, FL (US)

(21) Appl. No.: 14/016,359

(22) Filed: Sep. 3, 2013

(51) Int. Cl. A23L 1/30

(52) U.S. Cl. CPC A23L 1/3014
USPC 426/2; 426/61

(57) ABSTRACT

The present invention provides a lozenge preparation comprising a probiotic organism such as lactobacillus in different concentrations and placed in a specific location in the lozenge where survivability is preserved for a long time. The lozenge preparation is not limited to the probiotic inclusion but also in association with a varied dosage of prebiotics, such as Inulin, an oligosaccharide. The preparation may include sugar or may be sugar free. The invention further provides methods for producing such lozenges and uses for modulating embodiment and forming of center-tilled lozenges.

### FIELD OF THE INVENTION

The present invention relates to a lozenge preparation having a center filled with a dosage of live probiotic organisms as well spores of such organisms, and optionally the lozenge hard shell composition can include a dosage of a prebiotic ingredient. The preparation may comprise sugar or may be sugar free.

### BACKGROUND OF THE INVENTION

Pharmaceutical and nutraceutical active ingredients may be delivered orally by a number of means. These include a liquid, tablets (chewable and non-chewable), comestible solids, capsules, pills, granules, powder and lozenges. A lozenge is a solid preparation and also a solid preparation with a center portion that can be of a liquid, powder and fat base, containing one or more pharmaceutical or nutraceutical active ingredients. A lozenge is intended to dissolve slowly in the mouth and when it is center-filled, the center will be released at once at the end.

One group of such nutraceutical active ingredients are live organisms of the type of bacillus, lactobacillus and their spores. These organisms are recognized as probiotic and promote good intestinal health. These organisms of whatever species or origin, however, are very sensitive to temperature and moisture and the addition of such organisms into a non-water based center composition is the most suitable delivery system for their long-term survival.

Various attempts have been made to provide stable, viable probiotic supplements for oral dosage. For example, International Patent Application No. WO 2010086705 (Mogna) discusses a pediatric probiotic supplement having an inner part with chocolate coated probiotic bacteria and an outer coating. U.S. Pat. No. 8,404,228 (Gorbach) relates to a probiotic supplement containing a strain of lactobacillus that can survive gastic acidity and a B-glucan prebiotic component isolated from a natural source to support increased growth rate of the probiotic. None of these approaches appears to provide a solution to the problem of stability of the probiotic bacteria in an oral dosage delivery system. The foregoing applications are incorporated by reference herein.

There exists a need, therefore, for suitable delivery system that can maintain viability of live probiotic organisms, while providing a convenient and desirable delivery system.

### SUMMARY OF THE INVENTION

The present invention provides a lozenge and/or a center-filled lozenge composition comprising (a) probiotic organism or spores such organism; and (b) one or more ingredients that protect the organism or spore. The probiotic organism or spores may be present in a pediatric dose (500 million to 3 billion cells as a range of doses) or an adult dose (500 million to 6 billion cells as a range or doses). In a particular embodiment, the probiotic organism or spores are of the lactobacillus and other bacillus type. The preferred culture is composed of 100 billion (colony forming units or efu/gr).

The organism and its spores may be present in an amount of about 0.1 to about 15.0% (by weight) and preferably from 1.0 to 10% constituting the center of the lozenge. Further, the probiotic organism or spores may be in their pure state or may be encapsulated, particularly with, for example, magnesium silicate, guar gum, xantham gum, and/or gum Arabic and vegetable oils, partially or fully hydrogenated oils, fats and fractionated fats of vegetable origin.

As noted above, the lozenge may comprise one or more agent that constitutes the “shell” portion of the lozenge with a center portion referred to as “center,” In a particular embodiment, the center may be sugar free, or there may be a sugar and/or corn syrup composition containing a prebiotic ingredient. In another embodiment, the shell may be one or more polyols or oligosaccharides and free of sugar. The center may contain sugar in addition to vegetable oil and gelatin and thus may be a combination comprising (a) powdered or crystalline sucrose and an inert material such as calcium carbonate composition; or (b) one or more dry free flowing powders, such as silica gel and tricalcium phosphate; (c) a vegetable oil and (d) gelatin. In one embodiment, the center may comprise a center filler comprising 0.1-15% probiotic bacteria by weight in a base containing dry ingredient like; powder sugar, and corn syrup solids, or a base of Isomalt, lactose, mannitol of a vegetable oil, or fractionated oils or hydrogenated oils, or a base containing sugar, a vegetable oil, and gelatin or a gelatin derivative all in a water free system.

The invention further provides a method for modulating a subject's intestinal regularity, comprising administering an amount of the lozenges disclosed herein effective to modulate intestinal regularity of the subject.

The invention further provides methods for making a lozenge according to the present invention comprising:
(a) providing a lozenge having a hollow or empty center portion, the lozenge comprising, the lozenge corn syrup and sugar or one or more polyols or oligosaccharides:
(b) preparing a filler for the center portion of the lozenge comprising a probiotic organism in a base comprising vegetable oil, gelatin, and powder like agent of (a) to obtain a center composition and
(c) injecting the center into a solidifying candy shell composition to obtain said center-filled lozenge.

The invention further provides a oligosaccharides in the shell composition be of sugar and corn syrup composition and or of isomalt and/or of different types of polyols in combination with isomalt constituting the prebiotic composition. Such amount of oligosaccharides of the Inulin type can be present in the shell in the amount 0.1 to 100% and preferably 10 to 50% by weight.

### DETAILED DESCRIPTION OF THE PREFERRED EMBODIMENTS

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either both of those included limits are also included in the invention.

Unless defined otherwise, all technical and scientific terms used herein have the same meaning as commonly understood by a person one of ordinary skill in the art to which this invention pertains. Although any methods and materials similar or equivalent to those described herein can also be used in the practice or testing of the present invention, the preferred methods and materials are now described.

As used herein and in the appended claims, the singular forms “a,” “and” and “the” include plural references, unless the context clearly dictates otherwise.

### Lozenge Preparation

The lozenge may, as noted above, in addition to probiotic and prebiotic ingredient(s) may contain sugar, such as sucrose, polysaccharides, oligosaccharides, hydrogenated saccharides and corn syrup, maltodextrin, gelatin or protein fractions thereof, glycerin, botanical extracts, artificial sweeteners, such as sucralose, Acesulfame K, coloring and flavor ingredients. Sugars, in a specific embodiment, may be present as the largest percent ingredient ranging from about 30 to 99% and preferably from about 40 to 95% by weight. Corn syrup (e.g., corn syrup 36-65 DE (dextrose equivalents) or more particularly, corn syrup 42-43 DE), commercially found at 80% solids, also being a significant ingredient as well can range from 30 to 99% and preferably from about 40 to 95% by weight. The ratio of corn syrup to sugar is from about 1:10 to about 10:1 by weight. All other ingredients such as sweeteners (e.g., sucralose), botanicals, etc. as well as the probiotic organism as active ingredient in an encapsulated or pure state range from about 0.1 to 10% (w/v) of the whole lozenge and 10 to 50% (w/w) oldie center portion of the lozenge.

Polyols such as maltitol, mannitol, isomalt, xylitol and various types of HSH, (hydrogenated starch hydrolysates (e.g., HYSTAR® 3375, 4075, 6075)), can replace sucrose and/or corn syrup, in part and or completely. Hydrogenated starch hydrolysate may be defined as a broad group of polyols that contain substantial quantities of hydrogenated oligo- and polysaccharides in addition to any monomeric or dimeric polyols. The broad term HSH does not differentiate polyols having, for example, different levels of sweetness nor does it identify the principle polyol in the HSH. Common names for major HSH subgroups have, therefore, been developed. Examples of products called by the general term HSH include Roquette's 75/400 and Corn Products Specialty Ingredients HYSTAR® 3375 and Liquid HSH (STABILITE®) and a powdered HSH (STABILITE® SD). Polyols may be present in the amount of about 30-99% either singly or in combination of oligosaccharides and isomalt. The cerate filled lozenges will comprise a center composition of hydrogenated or partially hydrogenated vegetable oil or fractions thereof embedding the organism in different concentrations. These include but are not limited to palm oil (e.g, PARAMOUNT C®, PARAMOUNT B®, PARAMOUNT X®, PARAMOUNT XX®, all from Loders Croklaan, Channahon, Ill.), corn oil, coconut oil, soy oil, peanut oil, cottonseed oil, sunflower seed oil. Vegetable oil may be present in the amount of about 0.01-10% by weight.

The lozenges may also comprise gelatin or protein fractions, thereof. The gelatin may be animal-derived gelatin, chemically modified gelatin, physically modified gelatin, fish gelatin vegetable based gelatin-like compounds (such a carrageenan), and combinations thereof. A particularly suitable animal-derived gelatin may be obtained from pigskin or alternatively bovine bone. Gelatin may be present in the amount of about 0.1-10% by weight in the candy shell as well as in the center composition.

Other ingredients that may be present include but are not limited pectin, sweeteners, in particular, artificial sweeteners such as sucralose, Talen, flavors, such as cherry flavor, dyes such as red dye, particularly red azo dye (e.g., FD&C Red #40) or blue dye, particularly, brilliant blue FCF (e.g., FD&C Blue #1) and pigment such as titanium dioxide or natural colors from the fractionation of Beta carotene or vegetable and fruit extract or coccinilla-like carmine. Each of these ingredients is in the amount of about 0.001-5% by weight.

The probiotic bacillus or “probiotic bacteria” may include any strain of lactobacillus fit for human consumption, as well as spores thereof. Usually, the probiotic bacteria used in the present invention will be a strain that is naturally occurring in the gut flora. The probiotics used in the manufacture of products in accordance with the present invention can also be any of the following species: L. acidophilus, L. crispatus, L. gasseri, L. delbrueckii group, L. salivarius, L. casei, L. paracasei, L. plantarum group, L. rhamnosus, L. reuteri, L. brevis, L. buchneri, L. fermentum, B. adolescentis, B. angulatum, B. bifidum, B. breve, B. catenulatum, B. infantis, B. lactis, B. longum, B. psendocatenulatum, S. thermophilus among others.

### Production Methods

The candy base or candy vehicle contains ingredients such as sucrose, corn syrup, processing water, ingredients in encapsulated form or in a pure state, of mineral nature and optionally starches, HSH, oligosaccharides, isomalt and/or sorbitol, er other complex hydrogenated or non-hydrogenated saccharides. The ingredients are cooked using a conventional heat exchanger, continuous or interrupted, to a final cook temperature of about 280 to 360 F, preferably about 285 to 320 F, for the purpose of removing process water, with and without the aid of vacuum. Cooking results in a cooked sugar or sugar-free candy mass with a residual moisture content ranging from 0.02 to 5.0% and preferably from 0.08 to 3.0% to deliver the 0.01-3% active ingredient. Other ingredients such as color, sweeteners, botanicals flavorings etc., are added and dispersed to the molten candy mass. The candy mass is than cooled, by any conventional means, to an operating temperature of 160 to 190 F, preferably 170 to 180 F prior to forming. While the candy mass tempers or cools down to 140 to 160 F, and is still in a pseudo-plastic state, it is formed into a rope and wrapped around a Teflon coated pipe referred to as a filling pipe.

The filling pipe is connected to a dispensing pump to dynamically dispense a semi-liquid or powder mass constituting the center portion and such center through the means of the filling pipe is placed in the center of the candy mass in a ratio of 2 to 50% and preferably 5 to 20%. Such continuous candy mass with a center portion is dynamically taken into a forming machine referred to as forming die to shape uniform center filled pieces with a specific center amount in the range of 5 to 20% of the candy piece. Such formed pieces of center filled hard candy pieces of a specific weight are than formed by the means of forming/stamping machines. Uniform pieces at consistent weights are then obtained for this type of hard candy drug manufacturing.

### Uses

This type of vehicle allows the production of a pleasant tasting product for delivery of important probiotic and optionally prebiotic organism ingredients so that both the ingredients and the organisms are preserved in an alive and active state. This novel product with its unique delivery system and way to preserve the bacillus organism is convenient to take by the consumer for proper relief as compared to food preparations and to tablets or others preparations and has a pleasant taste and can be carried in a picket or purse. The present invention can be administered in adult and pediatric doses in a variety of forms.

### EXAMPLES

The examples set forth herein disclose various specific embodiments of a 3.6 gr center filled lozenges with a 5 to 15% center and preferably with a 15% center and methods of production. The examples are meant to be illustrative of the practices of the invention and are not intending to be limiting.

### Example 1

### Probiotic 6 Billion Organism Center-Filled/3.6 gr Drop with Corn Syrup/Sugar Base and Vegetable Oil Center

| | | Formula | |
|---|---|---|---|
| | Ingredient | % by weight | 200 |
| A | Sugar (dry basis) | 42.4 | 84.80 |
| | Corn Syrup (dry basis) | 42.4 | 84.80 |
| B | FD&C Red #40 (powder) | 0.02 | 0.04 |
| | FD&C Blue #1 (0.1% solution) | 0.03 | 0.06 |
| | Titanium Dioxide | 0.01 | 0.02 |
| | Citric Acid | 0.05 | 0.10 |
| | Water (color) and residual | 0.20 | 0.40 |
| C | Cherry Flavor FFS (215W32 | 0.24 | 0.48 |
| | Menthol | 0.05 | 0.10 |
| D | Lactobacillus organism (100 billion cfu/gr) | 1.60 | 3.20 |
| | (6 billion in 0.060 gr) | | |
| | Hydrogenated Palm oil | 13.0 | 26.00 |

Cook A to a residual moisture 1-3%. Add B and C to A and mix thoroughly before extruding. Extrude the pseudo-plastic candy mass onto a cooling surface. Transfer the cooled mass to a rope forming machine and center ingredients by a center filling pipe the center D into the warm shell while entering the forming machine that forms individual pieces.

### Example 2

### Probiotic 6 Billion Organisms in Fat Base Center—3.6 gr Drop Made of a Blend of Isomalt/Maltitol (50/50) Base

| | | Formula % by | |
|---|---|---|---|
| | Ingredient | weight | 200 |
| A | Isomalt (dry) | 42.13 | 84.26 |
| | Maltitol (Dry) | 42.13 | 84.26 |
| | Sucralose (powder) | 0.30 | 0.60 |
| B | Pectin Suspension (20% in PG) | 0.24 | 0.48 |
| C | FD&C Red #40 | 0.02 | 0.04 |
| | FD&C Blue #1 (0.1% solution) | 0.03 | 0.06 |
| | Titanium Dioxide | 0.01 | 0.02 |
| | Citric Acid | 0.05 | 0.1 |
| | Water (color) | 0.20 | 0.40 |
| D | Menthol | 0.05 | 0.10 |
| | Cherry Flavor FFS (215W32) | 0.24 | 0.48 |
| E | Lactobacillus organism (100 billion | 1.60 | 3.20 |
| | cfu/gr) (6 billion in 0.060 gr) | | |
| | Hydrogenated Palm oil | 13.0 | 26.00 |

Cook A to a residual moisture of less than 2%. Add B, C, and D to A and mix thoroughly before extruding. Extrude the pseudo-plastic candy mass onto a cooling surface. Transfer the cooled mass to rope forming equipment and add via center filling pipe the center E into the warm shell while entering the forming machine that forms individual pieces.

### Example 3

### Probiotic 6 Billion Organism in Fat Base Center/3.6 gr Drop Made with a Shell of 100% Isomalt as a Base

| | | Formula % by | |
|---|---|---|---|
| | Ingredient | weight | 200 |
| A | Isomalt (dry) | 84.31 | 169.62 |
| | Sucralose (powder) | 0.25 | 0.50 |
| B | Pectin Suspension (20% in PG) | 0.24 | 0.48 |
| C | FD&C Red #40 | 0.02 | 0.04 |
| | FD&C Blue #1 (0.1% solution) | 0.03 | 0.06 |
| | Titanium Dioxide | 0.01 | 0.02 |
| | Citric Acid | 0.05 | 0.1 |
| | Water (color) | 0.20 | 0.40 |
| D | Menthol | 0.05 | 0.10 |
| | Cherry Flavor FFS (215W32) | 0.24 | 0.48 |
| E | Lactobacillus organism (100 billion | 1.60 | 3.20 |
| | cfu/gr) (6 billion in 0.060 gr) | | |
| | Hydrogenated Palm oil | 13.0 | 26.00 |

Cook A to a residual moisture of less than 2%. Add B, C, and D to A and mix thoroughly before extruding. Extrude the pseudo-plastic candy mass onto a cooling surface. Transfer the cooled down mass to rope forming equipment and add via center filling pipe the center E into the warm shell while entering the forming machine that forms individual pieces.

### Example 4

### Prebiotic (with 1.0 gr of Inulin (Oligosaccharide as Soluble Fiber))—3.6 gr Drop Made with a Shell of 100% Isomalt as a Base

| | Ingredient | Formula % by weight | 200 |
|---|---|---|---|
| A | Isomalt | 71.11 | 142.22 |
| | Inulin (Oligosaccharide fiber) | 27.80 | 55.60 |
| | Sucralose (powder) | .25 | .50 |
| B | Pectin Suspension (20% in PG) | 0.24 | 0.48 |
| C | FD&C Red #40 | 0.02 | 0.04 |
| | FD&C Blue #1 (0.1% solution) | 0.03 | 0.06 |
| | Titanium Dioxide | 0.01 | 0.02 |
| | Citric Acid | 0.05 | 0.1 |
| | Water (color) | 0.20 | 0.40 |
| D | Menthol | 0.05 | 0.1 |
| | Cherry Flavor | 0.24 | 0.48 |

Cook A to a residual moisture of less than 2%. Add B, C, and D to A and mix thoroughly before extruding. Extrude the pseudo-plastic candy mass onto a cooling surface. Transfer the cooled down mass to rope forming equipment and while entering the forming machine form individual pieces.

### Example 5

### Prebiotic (with 1.0 gr of Inulin (Oligosaccharide as Soluble Fiber))—3.6 gr Drop Mode with as Shell of as 50/50 Blend of Sugar and Corn Syrup in a Dry Base

| | Ingredient | Formula % by weight | 200 |
|---|---|---|---|
| A | Sugar | 34.82 | 69.64 |
| | Corn Syrup | 34.82 | 69.64 |
| | Inulin (Oligosaccharide fiber) | 27.80 | 55.60 |
| B | FD&C Red #40 | 0.02 | 0.04 |
| | Citric Acid | 0.05 | 0.10 |
| | Water (Color) | 0.20 | 0.40 |
| C | Palm Oil | 2.00 | 4.00 |
| D | Menthol | 0.05 | 0.10 |
| | Cherry Flavor FFS (215W32) | 0.24 | 0.48 |

Cook A to a residual moisture of 1-3%. Add B, C, and D, to A and mix thoroughly before extruding onto cooling surface and form pieces with the forming die.

### Example 6

### Probiotic 6 Billion Organism in Fat Base Center-Filled with Prebiotic (1.0 gr of Inulin-Oligosaccharide as Soluble Fiber)/3.6 gr Drop Made of a Blend of Isomalt/Maltitol (50/50) Base

| | | Formula % by | |
|---|---|---|---|
| | Ingredient | weight | 200 |
| A | Isomalt (dry) | 42.13 | 84.26 |
| | Maltitol (Dry) | 42.13 | 84.26 |
| | Inulin (Oligosaccharide fiber | 27.80 | 55.60 |
| | Sucralose (powder) | 0.30 | 0.60 |
| B | FD&C Red #40 | 0.02 | 0.04 |
| | FD&C Blue #1 (0.1% solution) | 0.03 | 0.06 |
| | Citric Acid | 0.05 | 0.1 |
| | Water (color) | 0.20 | 0.40 |
| C | Menthol | 0.05 | 0.10 |
| | Cherry Flavor FFS (215W32) | 0.24 | 0.48 |
| D | Lactobacillus organism (100 billion | 1.60 | 3.20 |
| | cfu/gr) (6 billion in 0.060 gr) | | |
| | Hydrogenated Palm oil | 13.0 | 26.00 |

Cook A to a residual moisture of less than 2%. Add B and C to A and mix thoroughly before extruding. Extrude the pseudo-plastic candy mass onto a cooling surface. Transfer the cooled down mass to a rope forming equipment and add via center filling pipe the center D into the warm shell while entering the forming machine that forms individual pieces.

### Example 7

### Probiotic 6 Billion Organism in Fat Base Center-Filled with Prebiotic (1.0 gr of Inulin-Oligosaccharide as Soluble Fiber)/3.6 gr Drop Made of a 100% Isomalt Base

| | | Formula % by | |
|---|---|---|---|
| | Ingredient | weight | 200 |
| A | Isomalt (dry) | 84.26 | 168.52 |
| | Inulin (Oligosaccharide fiber | 27.80 | 55.60 |
| | Sucralose (powder) | 0.30 | 0.60 |
| B | FD&C Red #40 | 0.02 | 0.04 |
| | FD&C Blue #1 (0.1% solution) | 0.03 | 0.06 |
| | Citric Acid | 0.05 | 0.1 |
| | Water (color) | 0.20 | 0.40 |
| C | Menthol | 0.05 | 0.10 |
| | Cherry Flavor FFS (215W32) | 0.24 | 0.48 |
| D | Lactobacillus organism (100 billion | 1.60 | 3.20 |
| | cfu/gr) (6 billion in 0.060 gr) | | |
| | Hydrogenated Palm oil | 13.0 | 26.00 |

Cook A to a residual moisture of less than 2%. Add B, and C, to A and mix thoroughly before extruding. Extrude the pseudo-plastic candy mass onto a cooling surface. Transfer the cooled down mass to rope forming equipment and add via center filling pipe the center D into the warm shell while entering the forming machine that forms individual pieces.

### Example 8

### Probiotic 6 Billion Organism in Dry Powder Center-Filled Base with Prebiotic (1.0 gr Inulin-Oligosaccharide as Soluble Fiber)/3.6 gr Drop Made of a 100% Isomalt Base

| | | Formula % by | |
|---|---|---|---|
| | Ingredient | weight | 200 |
| A | Isomalt (dry) | 56.71 | 113.42 |
| | Inulin (Oligosaccharide fiber | 27.80 | 55.60 |
| | Sucralose (powder) | 0.30 | 0.60 |
| B | FD&C Red #40 | 0.02 | 0.04 |
| | Citric Acid | 0.05 | 0.1 |
| | Water (color) | 0.20 | 0.40 |
| C | Menthol | 0.05 | 0.10 |
| | Cherry Flavor FFS (215W32) | 0.24 | 0.48 |
| D | Lactobacillus organism (100 billion | 1.60 | 3.20 |
| | cfu/gr) (6 billion in 0.060 gr) | | |
| | Silica gel (Syloid 244) | 0.03 | |
| | Tri-calcium Phosphate (powder) | 3.00 | |
| | Fine powder sugar (80 mesh) | 10.0 | 26.00 |

Cook A to a residual moisture of less than 2%. Add B, and C, to A and mix thoroughly before extruding. Extrude the pseudo-plastic candy mass onto cooling surface. Transfer the cooled down mass to a rope forming equipment and add via center filling pipe the center D into the warm shell while entering the forming machine that forms individual pieces.

The invention described and claimed herein is not to be limited in scope by the specific embodiments herein disclosed, since these embodiments are intended as illustrations of several aspects of the invention. Any equivalent embodiments are intended to be within the scope of this invention. Indeed, various modifications of the invention in addition to those shown and described herein will become apparent to those skilled in the art from the foregoing description. Such modifications are also intended to fall within the scope of the appended claims.

What is claimed is:

1. A probiotic oral dosage supplement comprising:
an outer shell defining a hollow center, the outer shell comprising corn syrup, sugar, or one or more polyols or oligosaccharides capable of hardening to protect and contains center content;
a center filter comprising 0.1-15% probiotic bacteria by weight in a base containing dry ingredient like; powder sugar, and corn syrup solids, or a base of Isomalt, lactose, mannitol of a vegetable oil, or fractionated oils or hydrogenated oils, or a base containing sugar, a vegetable oil, and gelatin or a gelatin derivative all in a water free system.

2. The probiotic supplement according to claim 1, wherein the outer shell comprises sugar and corn syrup, and/or isomalt.

3. The probiotic supplement according to claim 2, wherein an isomalt is combined with one or more polyols.

4. The probiotic supplement according to claim 1, wherein the outer shell comprises a prebiotic substance.

5. The probiotic supplement according to claim 4, wherein the prebiotic substance is inulin, which is present in the outer shell an amount ranging from 0.1 to 100% by weight.

6. The probiotic supplement according to claim 1, wherein the supplement is a lozenge and the probiotic bacteria and its spores comprise about 1.0% to about 10% by weight of the center of the supplement.

7. The probiotic supplement according to claim 1, wherein the probiotic organism is a lactobacillus strain.

8. A method of making a probiotic supplement for oral administration, comprising:
forming a candy base or vehicle comprising sugar, corn syrup and water;
heating the candy base or vehicle to remove water therefrom to obtain a cooked candy base having a residual moisture content ranging from about 0.02% to about 5.0%;
cooling the candy base or vehicle to a soft state and forming the candy base into a rope;
wrapping the rope around a filling pipe;
preparing a powder or semi-liquid center filler containing probiotic bacteria in a stabilizing base including vegetable oil, and optionally sugar and/or gelatin;
dispensing the semi-liquid or powder center filler into the center of the candy base or vehicle in a ratio of about 2 to 50% by weight of the probiotic supplement.

9. A sugar-free stable probiotic supplement in the form of a center filled candy lozenge comprising:
an outer hollow candy-like shell comprising isomalt, inulin, one or more polyols, and one or more oligosaccharides; and
a semi-liquid or powered center comprising probiotic bacteria admixed with a vegetable oil, a free flowing power comprising silica gel, tricalcium phosphate and a sugar-free sweetening and/or flavoring agent.

10. A probiotic supplement according to claim 1, wherein the probiotic bacteria is a lactobacillus strain and spores thereof, and the probiotic bacteria is present in an amount of about 0.1 to about 15.0% by weight.

11. A probiotic supplement according to claim 1, wherein the probiotic bacteria is a lactobacillus strain and spores thereof, and the probiotic bacteria is present in an amount of about 1.0 to about 10% by weight of the center of the lozenge.

12. A probiotic supplement according to claim 1, wherein the outer shell or the center further comprises a prebiotic agent.

13. A probiotic supplement according to claim 12, wherein prebiotic agent is inulin.

14. A method for treating a patient suffering from irregularity or constipation comprising administering to the patient an amount of the probiotic supplement of claim 1 effective to alleviate symptoms of irregularity or constipation.

15. A method for treating an imbalance or insufficiency of intestinal flora in a patient comprising administering to the patient an amount of the probiotic supplement of claim 1 effective to alleviate intestinal flora imbalance or insufficiency.
